(19) United States
(12) Patent Application Publication
(10) Pub. No.: US 2005/0073462 A1
(43) Pub. Date: Apr. 7, 2005

(54) Multi-band antenna

(76) Inventors: Huei Lin, Taoyuan (TW); Nen-Yen Wu, Taoyuan City (TW)

Correspondence Address: RABIN & Berdo, PC, 1101 14TH STREET, NW, SUITE 500, WASHINGTON, DC, 20005, US

(21) Appl. No.: 10/957,728

(22) Filed: Oct. 5, 2004

(30) Foreign Application Priority Data
Oct. 6, 2003 (TW) 92127719

(51) Int. Cl. H01Q 1/24; H01Q 1/48

(52) U.S. Cl. 343/702; 343/846

(57) ABSTRACT

A multi-band antenna includes a resonance frequency regulator, a ground device, a short-circuiting device and a feed-in line. The resonance frequency regulator provides a first resonance mode and a second resonance mode respectively corresponding to the first band and the second band. The ground device includes a main ground surface, a first ground regulator, and a second ground regulator. The main ground surface includes a first ground point corresponding to the first resonance mode, and a second ground point corresponding to the second resonance mode. The short-circuiting device has one end connected to the resonance frequency regulator, and the other end connected to the second ground point. The short-circuiting device has a feed-in point connected to the feed-in line for transmitting electromagnetic signals and the feed-in line connects with the first ground point.

This application claims the benefit of Taiwan application Serial No. 92127719, filed Oct. 6, 2003, the subject matter of which is incorporated herein by reference.

### BACKGROUND OF THE INVENTION

1. Field of the Invention

The invention relates in general to a multi-band antenna, and more particularly to an integrated-into-a-unit antenna, which radiates and receives multi-band electromagnetic waves via a single resonance structure.

2. Description of the Related Art

In wireless communication systems, an antenna is a medium for transmitting and receiving electromagnetic waves, and its electrical characteristics will influence the communication quality. Generally, a multi-path disturbance could be produced as the antenna is transmitting or receiving signals. One effective solution to the issue is to enhance the antenna diversity. As the system transmits signals having frequencies in a single band, two single-band antennas can be combined into an antenna diversity system. For the 5 GHz wireless local area network (WLAN) 802.11a, or the 2.4 GHz WLAN 802.11b, a master antenna and a slave antenna are generally provided to enhance the antenna diversity. The master antenna can radiate and receive signals while the slave one only functions to receive signals. The selection of antennas to receive the signals is determined by the intensity of the to-be-received signals. In addition, in the 2.4 GHz WLAN 802.11g, two antennas are both provided to radiate and receive signals, and one of them is selected to radiate and receive electromagnetic waves in various directions according to their characteristics.

However, according to the conventional skill, a dual-band or even a multi-band system almost uses multiple independent antennas or a compound antenna to enhance the antenna diversity and maintain the RF characteristics in each band. Therefore, at least four antennas are required to transmit signals of 2.4˜2.4835 GHz, 5.15˜5.35 GHz, 5.47˜5.725 GHz, and 5.725˜5.825 GHz in WLAN 802.11a/b/g. Such system design will increase RF system complication, reduce its reliability and increase the production cost.

Furthermore, a miniaturized multi-band antenna can radiate electromagnetic waves in multiple bands through a single resonance structure by the second harmonic effect. However, this multi-band antenna design is limited to the following fact: the signal bandwidth is difficult to be broadened owing to the fact that central resonance frequencies of these electromagnetic waves are related to each other by a multiple, and their corresponding bandwidths are narrow. For example, for a dual-band antenna used in the 2.4 GHz and 5 GHz WLAN, the 5 GHz-band characteristics are provided by doubling the 2.4 GHz-band characteristics and adjusting the structure parameters of the antenna. Therefore, the performance of transmitting high-frequency electromagnetic signals is usually unsatisfied. Obviously, this antenna design cannot be applied to transmit signals of 2.4˜2.4835 GHz, 5.15˜5.35 GHz, 5.47˜5.725 GHz, and 5.725˜5.825 GHz in WLAN 802.11a/b/g because these bands are not related to each other by a multiple and the whole bandwidth of the 5 GHz band is quite large (1 GHz).

### SUMMARY OF THE INVENTION

It is therefore an object of the invention to provide a multi-band antenna, which can radiate and receive electromagnetic waves in multiple bands, including the operating frequencies of WLAN 802.11a/b or WLAN 802.11a/g, via an integrated-into-a-unit single resonance structure. By using metal shielding and a specific grounding mode, good RF characteristics, good electromagnetic compatibility, low system complication, high reliability and low cost can all be provided in the invention under the requirement of the whole system designed to be small.

The invention achieves the above-identified objects by providing a multi-band antenna system, which is an integrated-into-a-unit conducting structure for radiating and receiving electromagnetic signals having frequencies in a first band and a second band. The multi-band antenna includes a resonance frequency regulator, a ground device, a short-circuiting device, and a feed-in line. The resonance frequency regulator provides a first resonance mode and a second resonance mode respectively corresponding to the first-band and the second-band. The ground device includes a main ground surface, a first ground regulator and a second ground regulator. The main ground surface includes a first ground point and a second ground point respectively corresponding to the first resonance mode and the second resonance mode. The first ground regulator is connected to the main ground surface for regulating the impedance match in the first resonance mode and the bandwidth of the first band while the second ground regulator is connected to the main ground surface for regulating the impedance match in the second resonance mode and the bandwidth of the second band. The short-circuiting device has one end connected to the resonance frequency regulator, and the other end connected to the second ground point. The feed-in line is connected to the feed-in point of the short-circuiting device for transmitting the electromagnetic signals, and is connected to the first ground point. The resonance frequency regulator includes a first radiation arm and a second radiation arm respectively corresponding to the first resonance mode and the second resonance mode. The length of the first and the second radiation arms can be changed to adjust the central frequencies of the first band and the second band.

A first gap, formed between the first ground regulator and the resonance frequency regulator and equivalent to a first capacitance, is provided for regulating the impedance match in the first module and the bandwidth of the first band while a second gap, formed between the second ground regulator and the resonance frequency regulator and equivalent to a second capacitance, is provided for regulating the impedance match in the second module and the bandwidth of the second band. The total area of the ground device can be changed to adjust the impedance match in the first and the second resonance modes and the bandwidth of the first and the second bands. The distance between the first and the second ground points can be also changed to adjust the impedance match in the first and the second resonance modes. The main ground surface is electrically coupled to a shielding metal for improving the radiation performance of the antenna. The more the feed-in point on the short-circuiting device approaches the end of the short-circuiting device connected to the resonance frequency regulator, the higher the central frequency of the first band becomes.

The invention achieves the above-identified objects by providing a notebook computer including a base module and a display. The display includes two multi-band antennas and a shielding metal. Two multi-band antennas are located symmetrically to the center of the display for radiating and receiving the electromagnetic signals having frequencies in the first band and the second band. Each multi-band antenna includes a positive electrode plate, a negative electrode plate, a short-circuiting plate, and a feed-in line. The positive electrode plate includes a first radiation arm and a second radiation arm for respectively providing a first resonance mode corresponding to the first band and a second resonance mode corresponding to the second band. The required central frequencies of the first band and the second band can be given by adjusting the length of the first and the second radiation arms and the short-circuiting plate. The negative electrode plate includes a main ground surface, a first ground regulator, and a second ground regulator. The main ground surface includes a first and a second ground points respectively corresponding to the first and the second resonance modes. The first ground regulator is connected to the main ground surface for regulating the impedance match in the first resonance mode and the bandwidth of the first band while the second ground regulator is connected to the main ground surface for regulating the impedance match in the second resonance mode and the bandwidth of the second band. In addition, the short-circuiting plate has one end connected to the positive electrode plate and the other end connected to the second ground point. The short-circuiting plate has a feed-in point connected to the feed-in line, which transmits the electromagnetic signals to a RF module in the base module. The feed-in line is further connected to the first ground point.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a schematic view of the multi-band antenna according to a preferred embodiment of the invention;

FIG. 1B is a perspective view of the multi-band antenna 100 in FIG. 1A;

FIG. 1C is a schematic view of the current paths as the antenna is operated in the first and the second resonance modes according to a preferred embodiment of the invention;

FIG. 2A illustrates an upper view of the resonance frequency regulator in FIG. 1A composed of two radiation arms expanded at the connecting point A1;

FIG. 2B illustrates an upper view of the resonance frequency regulator in FIG. 1A composed of three radiation arms expanded at the connecting point A1;

FIG. 3 is a diagram of return loss measurement of the antenna according to a preferred embodiment of the invention;

FIG. 4 is a schematic view of the notebook computer according to a preferred embodiment of the invention; and

FIG. 5 illustrates the isolation of the signal transmission between the two antennas in FIG. 4.

### DETAILED DESCRIPTION OF THE INVENTION

The main feature of the multi-band antenna in the invention lies on electromagnetic waves in multiple bands, including operating frequencies of WLAN 802.11a/b or WLAN 802.11a/g, can be radiated by an integrated-into-a-unit single resonance structure, and many advantages, such as small volume, low cost, low system complication, good RF characteristics, and good electromagnetic compatibility can be provided by suitable metal shielding and grounding design.

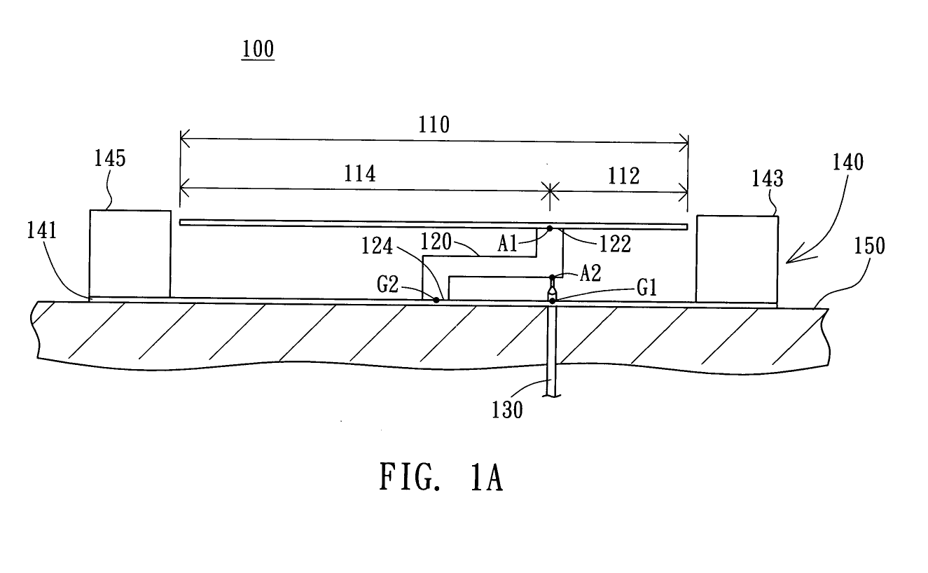

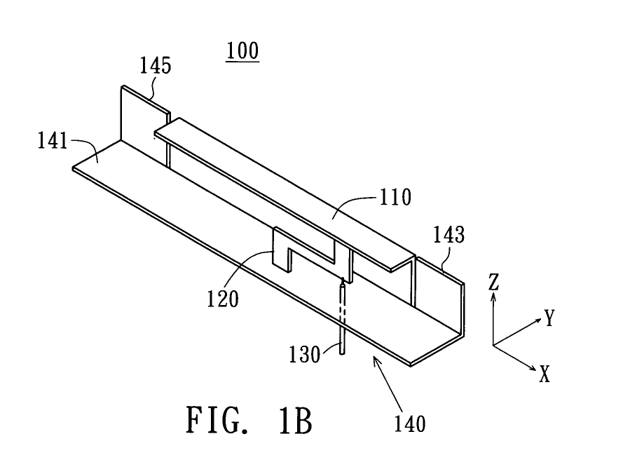

Referring to FIG. 1A, a schematic view of the multi-band antenna according to a preferred embodiment of the invention is shown. Two bands of 2.4 GHz and 5 GHz are taken as an example in the following description. The multi-band antenna 100 includes a resonance frequency regulator 110, a short-circuiting device 120, a feed-in line 130, and a ground device 140. The resonance frequency regulator 110, used as a positive electrode plate, connects with the first end 122 of the short-circuiting device 120, and is divided into a first radiation arm 112 and a second radiation arm 114 at the connection point A1. The first and the second radiation arm 112 and 114 are respectively used for providing a first and a second resonance modes to receive or radiate the corresponding electromagnetic signals having frequencies in the first band (5 GHz for example) and the second band (2.4 GHz for example). The second end 124 of the short-circuiting device 120 is connected to the ground device 140.

In addition, the short-circuiting device 120 includes a feed-in point A2 for connecting with the feed-in line 130, which is further connected to a RF module (not shown in FIG. 1A) for transmitting electromagnetic signals. The ground device 140, used as a negative electrode plate, includes a main ground surface 141, a first ground regulator 143, and a second ground regulator 145. The main ground surface 141 is connected to the feed-in line 130 at the first ground point G1, corresponding to the first resonance mode, and is connected to the second end 124 of the short-circuiting device 120 at the second ground point G2, corresponding to the second resonance mode. The first and the second ground regulators 143 and 145 can be used for respectively regulating the impedance match in the first and the second resonance modes and the bandwidth of the first and the second bands. The shielding metal 150 is connected to the main ground surface 141 for improving radiation performance of the antenna 100.

Referring to FIG. 1B, a perspective view of the multi-band antenna 100 in FIG. 1A is shown. As described above, the multi-band antenna 100 is a resonance structure composed of the resonance frequency regulator 110, the ground device 140, and the short-circuiting device 120, which can be manufactured into a unit by a sheet of metal in suitable stress process. In addition to the feed-in point A2, no other welding points exist on the resonance structure, which is one of the features of the invention. The integrated-into-a-unit design can reduce the production cost, increase the stability in the RF characteristics, and firm the whole structure of the multi-band antenna 100.

Referring to FIG. 1C, a schematic view of the current paths as the antenna is operated in the first and the second resonance modes according to a preferred embodiment of the invention is shown. Another feature of the invention lies on the central frequencies of the first band and the second band can be adjusted by changing the length of the first and the second radiation arms 112 and 114. For example, when the designed antenna has the central frequency of the first band lower than the required 5 GHz, the first radiation arm 112 should be shortened. Or when the designed antenna has the central frequency of the second band higher than the required 2.4 GHz, the second radiation arm 114 should be elongated.

The resonance ground points of the first band and the second band are respectively configured at the first ground point G1 and at the second ground point G2. Such design results that the resonance current corresponding to the first band (5 GHz) flows from the feed-in point A2 toward the first end 122, through the first radiation arm (the short one) 112, and then flows along the original path back to the first ground point G1 while the resonance current corresponding to the second band (2.4 GHz) flows from the feed-in point A2 toward the first end 122, through the second radiation arm (the long one) 114, and then flows along the original path through the feed-in point A2, and the short-circuiting device 120 back to the second ground point G2. Therefore, the first resonance mode and the second resonance mode respectively corresponding to the first band and the second band can be provided.

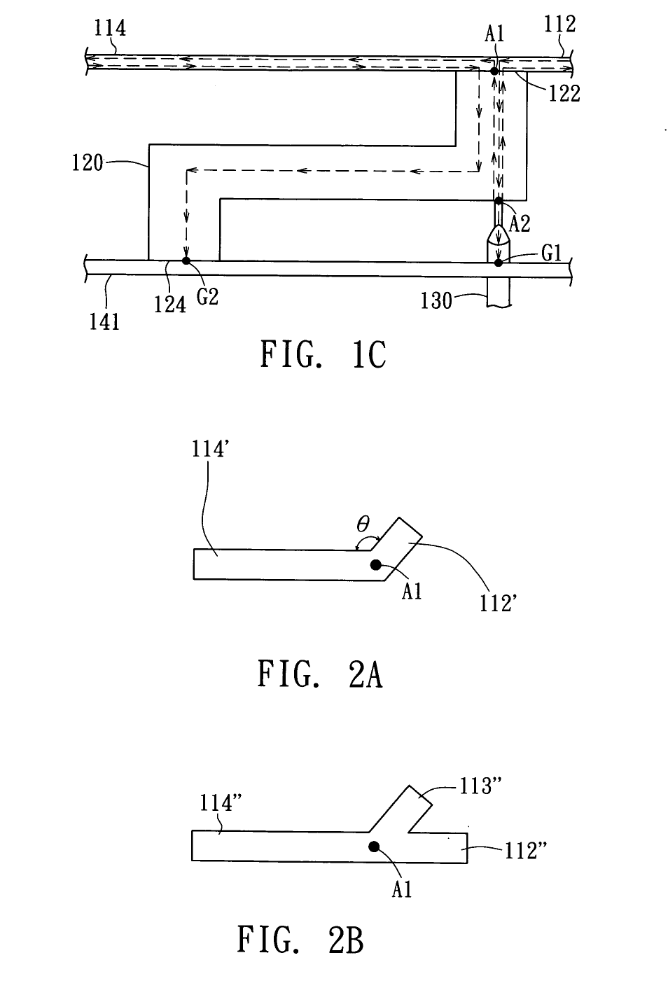

Although the resonance frequency regulator 110 is illustrated by taking the rectangle positive electrode plate as an example according to the above-mentioned embodiment, the resonance frequency regulator 110 in the invention can also be a resonance conductor having multiple arms expanded from the connecting point A1 with the corresponding signal bands determined by their arm lengths. For example, FIG. 2A illustrates an upper view of the first radiation arm 112′ and the second radiation arm 114′. The longer the radiation arm is, the lower the resonance frequency becomes. The included angle θ between the first and the second radiation arms 112′ and 114′ can be varied, and the two resonance bands as described above can still be provided by suitably designing the ground device 140 and adjusting impedance match and signal bandwidth. In addition, according to the same principle, three resonance bands, such as a 2.4 GHz band, a 5 GHz band of WLAN and a signal band of a mobile phone, can be provided by designing three radiation arms expanded at the connecting point A1 as the three radiation arms 112″, 113″ and 114″, shown in FIG. 2B. Three resonance modes corresponding to three bands can then be provided by the suitable design of the short-circuiting device 120 and the ground device 140.

Moreover, although the short-circuiting device 120 is illustrated by a right-angled N-typed plate as an example, it can be formed as another shape in real practice as long as two different current paths as described above can be formed to provide two resonance modes as it has the first end 122 connected to the resonance frequency regulator 110, the second end 124 connected to the main ground surface 141, and a feed-in point A2 not overlapping the connecting point A1 and the second ground point G2.

As mentioned above, the resonance central frequency mainly depends on the lengths of the first radiation arm 112 and the second radiation arm 114. However, the length of the short-circuiting device 120 and the location of the feed-in point A2 on the short-circuiting device 120 will also influence the resonance frequency. The shorter the short-circuiting device 120 is or the more the feed-in point A2 approaches the first end 122, the higher the central frequency of the first band will become. Furthermore, the resonance performance depends on the impedance match and the magnitude of the bandwidth. The gap formed between the ground regulator 143 or 145 and the resonance frequency regulator 110 has a capacitance effect. The size of the gaps and the area of the ground device 140 can be changed to adjust the impedance match in the first and the second resonance modes and the bandwidth of the first and the second bands. Moreover, the distance between the first and the second ground points G1 and G2 will also influence the return loss in antenna radiation, thereby influencing the impedance match.

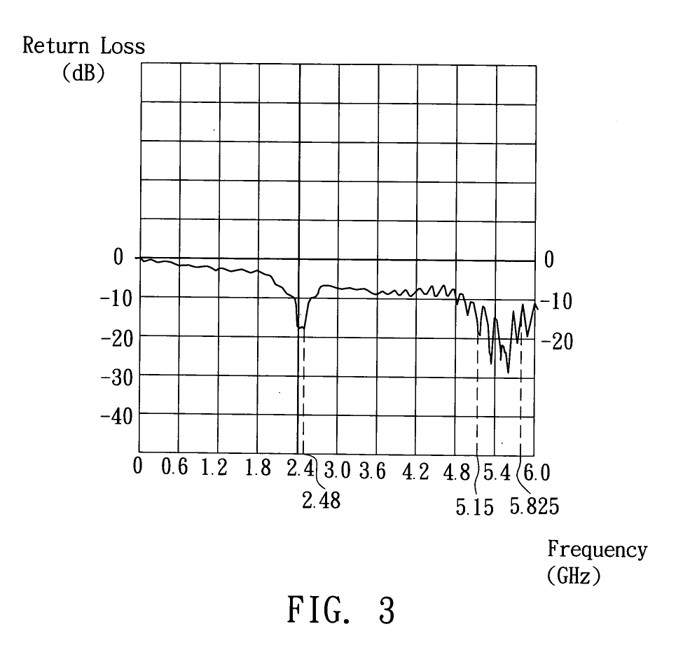

Referring to FIG. 3, a diagram of return loss measurement of the antenna 100 according to a preferred embodiment of the invention is shown. Under suitable consideration of all factors mentioned above in antenna design, it can be shown from FIG. 3 that the frequency range from 5.15 GHz to 5.825 GHz in the 5 GHz band of WLAN 802.11a has a return loss higher than 10 dB. The range of the available antenna signal frequency can be even extended to that from 4.9 GHz to 6.0 GHz (The return loss is still higher than 10 dB), which includes the 4.9 GHz band specifications applied in Japan and Australia. Under suitable adjustment of the impedance match, the antenna 100 in the invention can have a large bandwidth (about 1 GHz) in the 5 GHz band. In addition, for the frequency range from 2.4 GHz to 2.4835 GHz in the 2.4 GHz band of WLAN 802.11b or WLAN 802.11g, the return loss is also higher than 10 dB. According to the common industrial specifications, the 5 GHz band in antenna operation includes three sub-bands, which are 5.15 GHz to 5.35 GHz, 5.47 GHz to 5.725 GHz, and 5.725 GHz to 5.825 GHz. Therefore, the multi-band antenna 100 in the invention can radiate electromagnetic waves having frequencies in at least four bands via a single resonance structure.

Referring to the following Table 1 and Table 2, two tables respectively show the gain measurement of the antenna of the invention with different operating frequencies in the first band (5 GHz band) and the second band (2.4 GHz) on the X-Y plane as the antenna 100 is configured along the X-axis as shown in FIG. 1B. The peak gain corresponding to every frequency in the 2.4 GHz band is near to 0 dB shows that the 2.4 GHz-band radiation field pattern is close to a circle, and the peak gain corresponding to every frequency in the 5 GHz band is about 1.2 dB to 2.8 dB shows that the 5 GHz-band radiation field pattern is close to an ellipse. The average gain corresponding to every frequency in the 2.4 GHz band is higher than −2.5 dB, and that corresponding to frequencies in the 5 GHz band is higher than −4.5 dB shows that the antenna of the invention has good radiation performance. The peak gain in 5 GHz band should be higher than that in 2.4 GHz band because electromagnetic waves having frequencies in the 5 GHz band decay by distance faster than those in the 2.4 GHz band. When the 5 GHz-band and the 2.4 GHz-band electromagnetic waves are received at the same time, the radiation field pattern of the 5 GHz band should have higher peak gain so that electromagnetic signals having frequencies in two bands can be both received at the same distance. Although the high peak-gain design for signals in the 5 GHz band will increase the dead space, the dead space issue could be ignored as WLAN is usually set up indoor and signals can be received by various paths reflected from objects indoor. Therefore, the steady performance of the antenna in radiating and receiving signals is the main point in the invention.

TABLE 1

| Frequency range | 2.4 GHz band | | |
|---|---|---|---|
| Frequency (GHz) | 2.40 | 2.45 | 2.4835 |
| Peak Gain (dB) | 0.12 | 0.2 | 0.16 |
| Average Gain (dB) | −2.31 | −2.15 | −2.26 |

TABLE 2

| Frequency range | 5 GHz band | | | | |
|---|---|---|---|---|---|
| Frequency (GHz) | 5.15 | 5.25 | 5.35 | 5.47 | 5.5975 |
| Peak Gain (dB) | 2.76 | 2.45 | 2.6 | 2.26 | 1.68 |
| Average Gain (dB) | −3.98 | −4.16 | −3.83 | −2.89 | −3.06 |
| Frequency (GHz) | 5.625 | 5.725 | 5.775 | 5.825 | |
| Peak Gain (dB) | 1.23 | 1.56 | 1.75 | 2.01 | |
| Average Gain (dB) | −3.07 | −3.54 | −4.08 | −3.14 | |

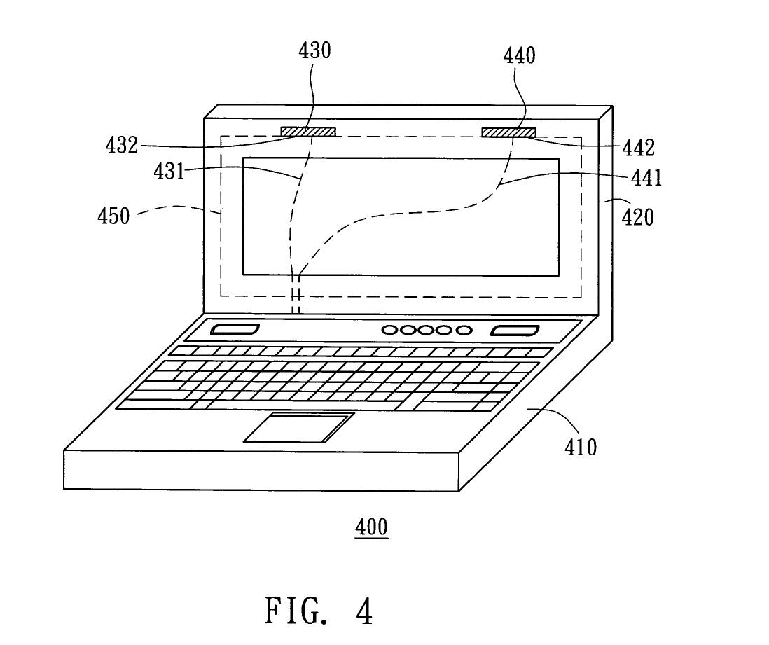

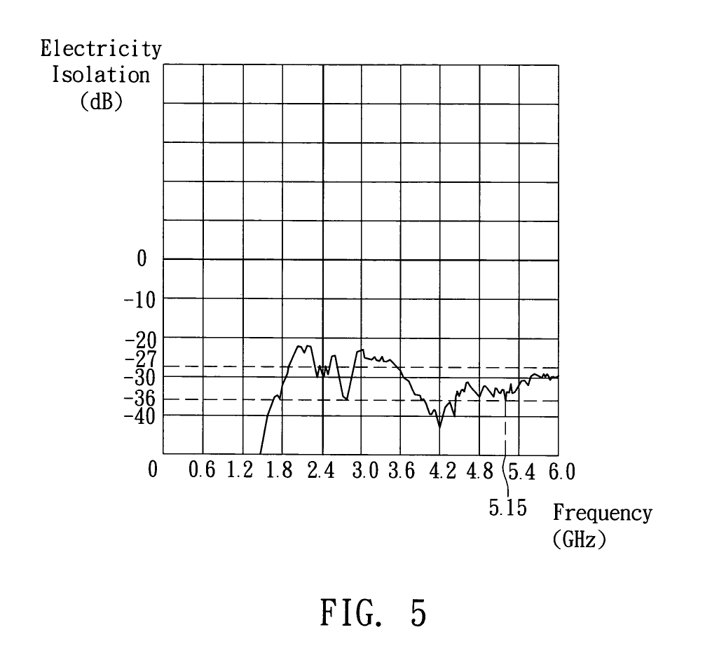

Referring to FIG. 4, a schematic view of the notebook computer according to a preferred embodiment of the invention is shown. The notebook computer 400 includes a base module 410 and a display 420. Two multi-band antennas 430 and 440 in the invention are configured at the upper edge of the display 420 and symmetrically to the center of the display 420 to form a multi-band spatial diversity system. The ground surfaces 432 and 442 of the multi-band antennas 430 and 440 are electrically coupled to the shielding metal 450, and the feed-in lines 431 and 441 respectively corresponding to the antennas 430 and 440 are connected to a RF module (not shown in FIG. 4) in the base module 410 for transmitting electromagnetic signals. The multi-band antennas 430 and 440, configured symmetrically to the center of the display 420, have a better radiation isolation. Therefore, signal transmission in one antenna will not be interfered by the other one and special diversity can be enhanced. FIG. 5 illustrates the isolation of the signal transmission between the two antennas 430 and 440 in FIG. 4. The RF electricity isolation of the dual-antenna system as operated in the 2.4 GHz band and the 5 GHz band is respectively −27 dB and −36 dB, which are both quite good.

The advantages of the invention lie on the antenna is designed to be an integrated-into-a-unit conducting structure so that the production cost can be reduced and the reliability in RF characteristics can be improved. The antenna in the invention has a number of radiation arms expanded from the RF signal feed-in point, and each radiation arm has a different length corresponding to a different signal band. Therefore, a number of electromagnetic resonance modes can be provided by the single conducting structure to radiate signals having frequencies in a number of bands. Moreover, by designing different ground points corresponding to those radiation arms, the impedance match can be improved and the bandwidth of radiation bands can be increased. The antenna ground points are electrically coupled to the shielding metal so as to improve the electromagnetic radiation performance. The electromagnetic compatibility is provided to improve the RF characteristics of the system and the antenna, having a small volume and simple structure, is very suitable to be applied to the concealed-antenna system.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A multi-band antenna for radiating and receiving a plurality of electromagnetic signals, the electromagnetic signals having frequencies in a first band and a second band, the multi-band antenna comprising:
a resonance frequency regulator for providing a first resonance mode and a second resonance mode respectively corresponding to the first band and the second band;
a ground device comprising:
a main ground surface comprising a first ground point corresponding to the first resonance mode and a second ground point corresponding to the second resonance mode;
a first ground regulator connected to the main ground surface for regulating the impedance match in the first resonance mode and the bandwidth of the first band; and
a second ground regulator connected to the main ground surface for regulating the impedance match in the second resonance mode and the bandwidth of the second band;
a short-circuiting device comprising a first end connected to the resonance frequency regulator, a second end connecting to the second ground point, and a feed-in point; and
a feed-in line connected to the feed-in point for transmitting the electromagnetic signals wherein the feed-in line is connected to the first ground point.

2. The multi-band antenna according to claim 1, wherein the resonance frequency regulator comprises a first radiation arm and a second radiation arm, joined at the first end, respectively corresponding to the first resonance mode and the second resonance mode, and the length of the first radiation arm and the second radiation arm determines the central frequency of the first band and the second band.

3. The multi-band antenna according to claim 1, wherein the resonance frequency regulator is shaped as a rectangle.

4. The multi-band antenna according to claim 1, wherein the first band is a 5 GHz band.

5. The multi-band antenna according to claim 4, wherein the second band is a 2.4 GHz band.

6. The multi-band antenna according to claim 1, wherein the short-circuiting device is a right-angled N-typed plate.

7. The multi-band antenna according to claim 1, wherein a first gap is formed between the first ground regulator and the resonance frequency regulator, the size of which determines the impedance match in the first resonance mode and the bandwidth of the first band.

8. The multi-band antenna according to claim 1, wherein a second gap is formed between the second ground regulator and the resonance frequency regulator, the size of which determines the impedance match in the second resonance mode and the bandwidth of the second band.

9. The multi-band antenna according to claim 1, wherein the main ground surface is electrically coupled to a shielding metal for improving antenna radiation performance.

10. The multi-band antenna according to claim 1, wherein the multi-band antenna is an integrated-into-a-unit conducting structure.

11. A notebook computer comprising:
a base module; and
a display, comprising:
two multi-band antennas for radiating and receiving a plurality of electromagnetic signals, the electromagnetic signals having frequencies in a first band and a second band, each of the multi-band antennas comprising:
a positive electrode plate for providing a first resonance mode corresponding to the first band and a second resonance mode corresponding to the second band;
a negative electrode plate comprising:
a main ground surface comprising a first ground point corresponding to the first resonance mode and a second ground point corresponding to the second resonance mode;
a first ground regulator connected to the main ground surface for regulating the impedance match in the first resonance mode and the bandwidth of the first band; and
a second ground regulator connected to the main ground surface for regulating the impedance match in the second resonance mode and the bandwidth of the second band;
a short-circuiting device comprising a first end connected to the positive electrode plate, a second end connected to the second ground point, and a feed-in point;
a feed-in line connected to the feed-in point for transmitting the electromagnetic signals wherein the feed-in line is connected to the first ground point; and
a shielding metal electrically coupled to the main ground surfaces of the multi-band antennas.

12. The notebook computer according to claim 11, wherein the two multi-band antennas are configured symmetrically to the center of the display.

13. The notebook computer according to claim 11, wherein the positive electrode plate comprises a first radiation arm and a second radiation arm, joined at the first end, respectively corresponding to the first resonance mode and the second resonance mode, and the length of the first radiation arm and the second radiation arm determines the central frequency of the first band and the second band.

14. The notebook computer according to claim 11, wherein the first band is a 5 GHz band.

15. The notebook computer according to claim 14, wherein the second band is a 2.4 GHz band.

16. The notebook computer according to claim 11, wherein the short-circuiting device is a right-angled N-typed plate.

17. The notebook computer according to claim 11, wherein a first gap is formed between the first ground regulator and the resonance frequency regulator, the size of which determines the impedance match in the first resonance mode and the bandwidth of the first band.

18. The notebook computer according to claim 11, wherein a second gap is formed between the second ground regulator and the resonance frequency regulator, the size of which determines the impedance match in the second resonance mode and the bandwidth of the second band.

19. The notebook computer according to claim 11, wherein the multi-band antenna is an integrated-into-a-unit conducting structure.
